(19) United States
(12) Patent Application Publication
(10) Pub. No.: US 2013/0308496 A1
(43) Pub. Date: Nov. 21, 2013

(54) System and Method for Generic Multi-Domain Network Pruning

(71) Applicants: Rajeev Manur, Fremont, CA (US); Puneet Agarwal, Cupertino, CA (US)

(72) Inventors: Rajeev Manur, Fremont, CA (US); Puneet Agarwal, Cupertino, CA (US)

(73) Assignee: BROADCOM CORPORATION, Irvine, CA (US)

(21) Appl. No.: 13/591,480

(22) Filed: Aug. 22, 2012

Related U.S. Application Data
(60) Provisional application No. 61/649,547, filed on May 21, 2012.

(51) Int. Cl. H04L 12/28

(52) U.S. Cl. 370/255

(57) ABSTRACT

A system and method for generic multi-domain network pruning A generic mechanism that can control network pruning can be applied to a multi-domain context. In one embodiment, the pruning mechanism is implemented using a network pruning control table that can be accessed using a source domain identifier and a destination domain identifier. The source domain identifier is shared by network traffic that is received from any of a first plurality of network devices that are included in a source network domain and the destination network domain identifier is shared by network traffic destined to any of a second plurality of network devices that are included in a destination network domain.

This application claims priority to provisional patent application No. 61/649,547, filed May 21, 2012, which is incorporated by reference herein, in its entirety, for all purposes.

### BACKGROUND

### Field of the Invention

The present invention relates generally to networking and, more particularly, to a system and method for generic multi-domain network pruning

Introduction

Increasing demands are being placed upon the data communications infrastructure. These increasing demands are driven by various factors, including the increasing bandwidth requirements of Internet multimedia applications (e.g., distribution of news, financial data, software, video, audio and multi-person conferencing, etc). To accommodate the increasing demands, communication networks have grown in capacity and complexity.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an example of a networking infrastructure.

FIG. 2 illustrates an example of a switch that interfaces with multiple network domains.

FIG. 3 illustrates an example of a network pruning table.

FIG. 4 illustrates an example embodiment of a switch.

FIG. 5 illustrates a flowchart of a process of the present invention.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Today's networks are becoming increasingly complex as demand for network services continue to expand. Administration of such networks (e.g., data centers) is also expanding in complexity. To reduce the complexities in network administration, large networks can be segmented into multiple domains, each of which can be controlled and operated by a separate network operator. Each network domain can therefore have a separate control plane that is scoped within that network domain.

In topologies that are configured as multiple domains, pruning of network traffic (e.g., multi-cast traffic) can be a significant challenge. A generic mechanism that can control network pruning can be applied to the multi-domain context, thereby facilitating the growing practice of supporting a multi-domain topology. In one embodiment, the pruning mechanism is implemented by a switch that has access to a network pruning table that can be accessed using a source domain identifier and a destination domain identifier. The source domain identifier is shared by network traffic that originates at any of a first plurality of network devices that are included in a source network domain and the destination network domain identifier is shared by network traffic destined to any of a second plurality of network devices that are included in a destination network domain. In one embodiment, the source network domain identifier and the destination domain identifier operate as a key into the network pruning table.

Access of the network pruning table using the source network domain identifier and the destination domain identifier enables the switch to identify a prune action associated with the source network domain identifier and the destination domain identifier. In one embodiment, an enable prune action retrieved from the network prune control table indicates that network traffic should be forwarded, while a disable prune action retrieved from the network prune control table indicates that network traffic should not be forwarded. When applied to network traffic, the enable and disable prune actions ensure that loops are not created in the data plane of a configurable multi-domain network topology. As the network prune control table is configurable along with the configuration of a multi-domain network, the generic mechanism provides scalable network control.

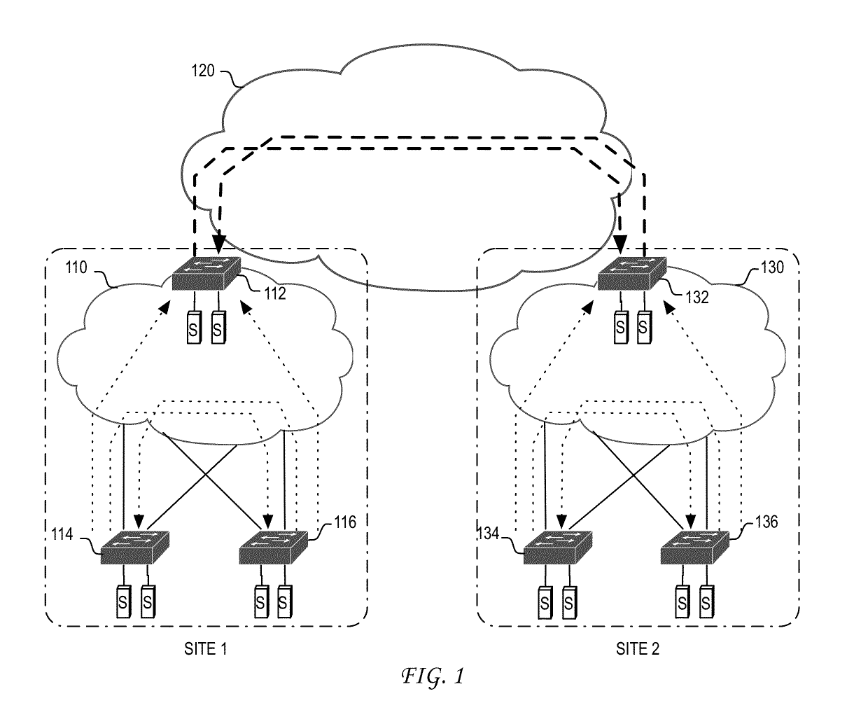

FIG. 1 illustrates an example of a networking infrastructure that can include multiple network domains. As illustrated, the networking infrastructure includes two sites (Site 1 and Site 2) that are interconnected by inter-site transport network 120. Inter-site transport network 120 can support overlay tunnels (e.g., L2 Generic Routing Encapsulation tunnels), which are illustrated in FIG. 1 using the bold dashed lines.

Site 1 includes intra-site transport network 110, which further includes switch 112. As illustrated, switch 112 is coupled to a plurality of servers. Site 1 also includes switches 114 and 116, each of which can be coupled to a plurality of servers. As illustrated, switches 114 and 116 are coupled to intra-site transport network 110 via links that can support overlay tunnels (e.g., L2 Generic Routing Encapsulation tunnels). These overlay tunnels are illustrated in FIG. 1 using lighter dashed lines. In one topology, switches 114 and 116 as well as their supported servers can be included in a first defined access domain grouping of network devices.

Similarly, Site 2 includes intra-site transport network 130, which further includes switch 132. Switches 134 and 136, each of which can be coupled to a plurality of servers, are coupled to intra-site transport network 130 via links Similar to Site 1, switches 134 and 136 as well as their supported servers can be included in a second defined access domain grouping of network devices.

As FIG. 1 illustrates, the network topology that can support multiple sites, can lead to the definition of multiple domains. In the illustrated example, the domains include access domains, intra-site domains, and inter-site domains. As would be appreciated, other domains beyond those identified by the example of FIG. 1 can be defined. Indeed, it is a feature of the present invention that the administration of network pruning can be applied to an arbitrarily defined number of network domains using a generic structured control mechanism.

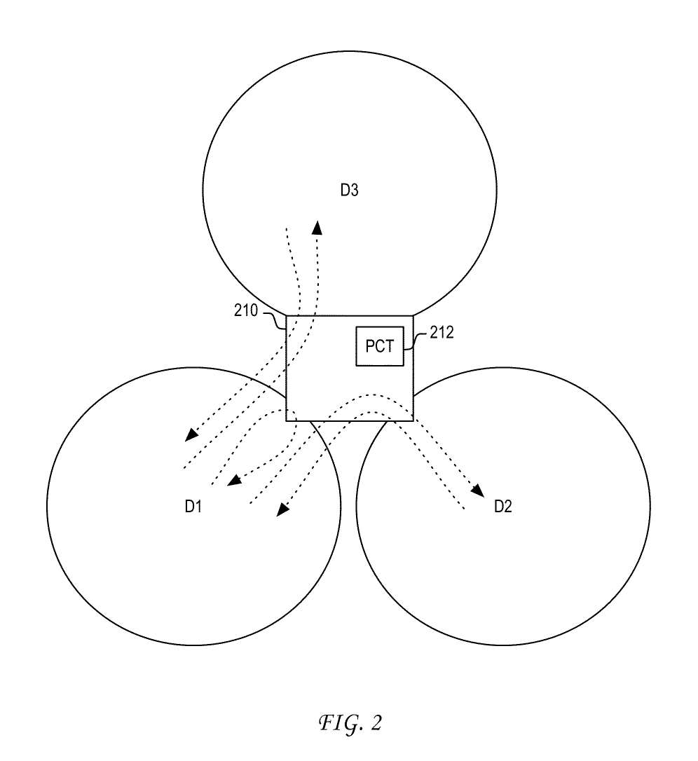

Regardless of the number of domains that can be defined in a network, it is increasingly common that a network device (e.g., label switch router) can be designed to interface with multiple network domains. FIG. 2 illustrates an example of a network device that can interface with multiple network domains.

As illustrated, network device 210 (e.g., switch) can be designed to interface with domains D1, D2 and D3. As will become apparent from the following description, the principles of the present invention are not limited to a particular number of domains to which a network device would interface. The example interface of a network device interfacing with three network domains should therefore not be construed as limiting on the scope of the present invention. For simplicity of illustration, three network domains D1, D2 and D3 have been chosen to illustrates the generic mechanism. In one example, domains D1, D2 and D3 can represent an access domain, an intra-site domain, and an inter-site domain.

Network device 210 can be configured to route traffic to and from each of the network domains to which network device 210 is interfaced. To illustrate the routing of network traffic, consider network domain D1. As illustrated, network device 210 can route traffic from domain D1 to domain D1, traffic from domain D1 to domain D2, traffic from domain D1 to domain D3, traffic from domain D2 to domain D1 and traffic from domain D3 to domain D1. If control over the forwarding of traffic represented by each of these routings is not properly exercised, then loops in the data plane can occur. In one example, network device 210 can be further configured such that traffic from D2 should not be allowed go back to D2, and that traffic from D3 should not be allowed to go back to D3. As would be appreciated, the particular configuration of actions would be dependent on the topology of the network.

It is a feature of the present invention that control over network pruning in the context of multiple network domains can be effected by network device 210 in a structured manner. In one embodiment, the control over network pruning in the context of multiple domains is effected using a network prune control table 212 that is accessible by network device 210. In general, network prune control table 212 is designed to provide network device 210 with network prune control actions that are network domain based.

In one embodiment, the network prune control table is defined using a source network domain identifier and a destination network domain identifier. In this context, each defined network domain has an associated network domain identifier. A network domain can include a plurality of network devices (e.g., switches, servers, etc.). Accordingly, traffic that is associated with any of a plurality of network devices that are included within a defined network domain would therefore share the network domain identifier for that defined network domain.

Traffic that flows through a switch/router device in a network can have associated therewith a source network domain identifier and a destination network domain identifier. In one embodiment, the source network domain identifier is determined using a source address (e.g., MAC source address, source port/interface/overlay tunnel interface on which the traffic is received, etc.) of the network traffic, while the destination network domain identifier is determined using a destination address (e.g., MAC destination address, source port/interface/overlay tunnel interface on which the traffic is sent out, etc.) of the network traffic.

In one embodiment, the determined source network domain identifier and destination network domain identifier can be used as a key into the network prune control table to determine a prune action for network traffic. To facilitate this form of network control, the network prune control table can be defined to identify the particular routing policies that are defined for network device 210. In one example, the particular routing policy for network device 210 can be defined to ensure that loops in the data plane do not occur.

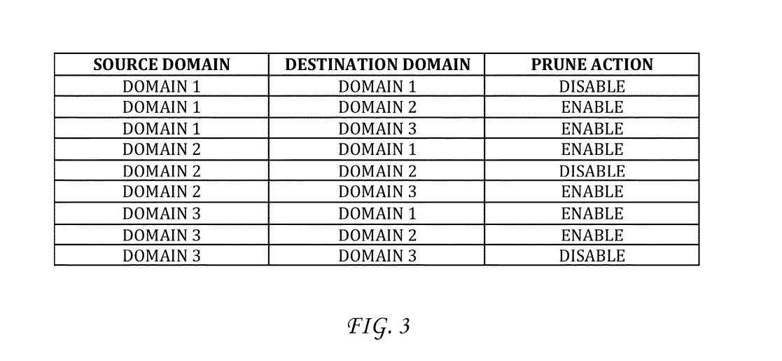

FIG. 3 illustrates an example embodiment of a network prune control table. As illustrated, the network prune control table can be based on a key that includes a source domain identifier and a destination domain identifier. In one example, the source domain identifier and destination domain identifier can be a multi-bit field (e.g., three bits) that at least enables the identification of the full range of network domains that are the subject of control by the network device. The key into the network prune control table is designed for retrieval of a prune action. In one embodiment, such a prune action can be a single bit field that identifies whether the prune action is to disable the forwarding of network traffic or to enable the forwarding of network traffic.

In the example network prune control table of FIG. 3, the prune actions for the (source domain, destination domain) keys (Domain 1, Domain 1), (Domain 2, Domain 2), and (Domain 3, Domain 3) would each yield a disable action. This network control would dictate that the network device would not forward traffic back to the domain from which the traffic originated. The prune actions for the keys (Domain 1, Domain 2), (Domain 1, Domain 3), (Domain 2, Domain 1), (Domain 2, Domain 3), (Domain 3, Domain 1) and (Domain 3, Domain 2) would each yield an enable action, indicating that the network traffic should be forwarded.

As would be appreciated, the particular prune actions that are defined for a particular combination of source network domain and destination network domain would be dependent on the particular topology of the multiple network domains. What is significant is that the network prune control table enables such pruning in a structured manner relative to associated source network domain and destination network domain identifiers.

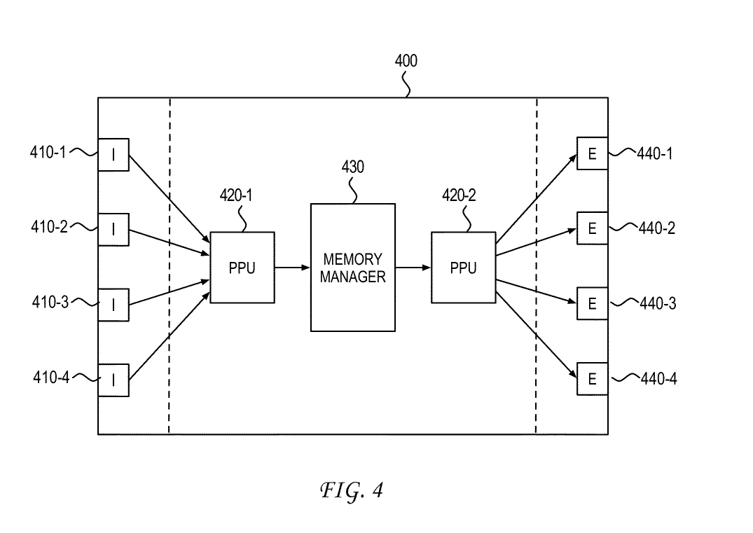

FIG. 4 illustrates an example embodiment of a switch that can be configured to incorporate the network pruning mechanism. As illustrated, switch 400 includes a plurality of ingress ports 410-1 to 410-4, each of which can provide connectivity to other network devices. As an example, each of ingress ports 410-1 to 410-4 can provide 10 Gbit/s Ethernet connectivity to other network devices. Similarly, switch 400 includes a plurality of egress ports 440-1 to 440-4, each of which can provide connectivity to other network devices. As described above, the one or more ingress ports and one or more egress ports can be associated with network devices in other network domains.

As further illustrated in FIG. 4, switch 100 includes packet processing units 420-1, 420-2 and memory manager 430. In one embodiment, packet processing units 420-1, 420-2 execute real-time operations on packets, such as framing/parsing, classification, traffic policing and shaping, modification, compression/encryption, queueing, etc. Control operations such as translation, route calculation, routing table updates, etc. can also be performed by packet processing units 420-1, 420-2. As would be appreciated, the specific configuration of the processing core of the switch is implementation dependent.

In one embodiment, switch 400 can be embodied as a shared memory buffer switch. In one application, the switch is a top-of-rack (TOR) switch that can connect to multiple servers.

In one embodiment, the network prune control table is stored by switch 400 in a manner that is accessible by the processing component that effects the network traffic forwarding decision. In one embodiment, the processing component is represented by a packet processor associated with an ingress pipeline. In another embodiment, the processing component is represented by a packet processor associated with an egress pipeline. As would be appreciated, the particular location of the processing component would be implementation dependent as the particular switch architectures can vary. Here, it should be noted that where one copy is being replicated to multiple destinations, the generic fine-grained pruning mechanism facilitates various traffic flows to share aggregate distribution trees within the network device, independent of the source/destination domains.

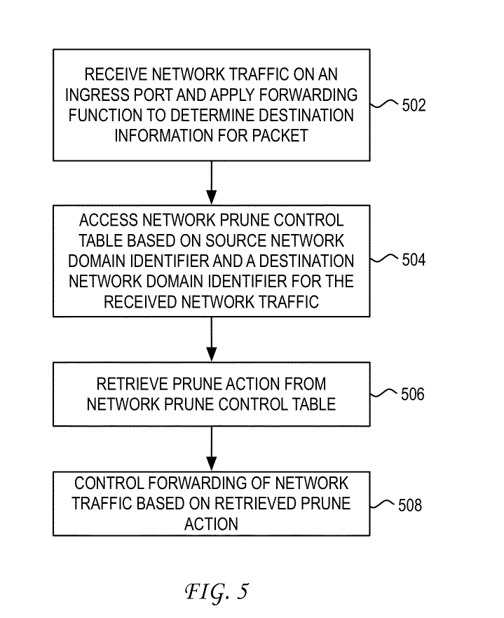

Having described a mechanism for pruning network traffic using a network prune control table, reference is now made to FIG. 5, which illustrates a flowchart of a process of the present invention. As illustrated, the process begins at step 502 where network traffic is received on an ingress port and a forwarding function is applied to determine the destination information for the packet. At step 504, the network prune control table is accessed based on a source network domain identifier and a destination network domain identifier that are derived from the received network traffic. In one embodiment, the source network domain identifier and the destination network domain identifier are used as a key into the network prune control table.

As would be appreciated the particular mechanism for deriving the source network domain identifier and the destination network domain identifier would be implementation dependent. In one embodiment, the source network domain identifier and the destination network domain identifier are derived by a packet processing unit in an ingress pipeline and stored in a switch control table for use by a processing unit responsible for determining a packet forwarding decision for the network traffic.

Having gained access to the network prune control table using the source network domain identifier and the destination network domain identifier, the prune action can then be retrieved at step 506. In one embodiment, the prune action can be represented as a single bit in the network prune control table.

Finally, at step 508, the forwarding of the network traffic can be dictated by the prune action retrieved form the network prune control table. In one embodiment, an enable prune action retrieved from the network prune control table indicates that network traffic should be forwarded, while a disable prune action retrieved from the network prune control table indicates that network traffic should not be forwarded.

As has been described, a mechanism has been provided that enables network pruning to be applied in a structured manner. Such a structured mechanism enables network prune control to be applied to configurable network domains.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A method, comprising:
receiving network traffic on an ingress port of a switch;
identifying an egress port for multicast forwarding of said received network traffic;
retrieving, by said switch, a prune action from a network prune control table using a source domain identifier for a source network domain to which said ingress port is associated and a destination domain identifier for a destination network domain to which said egress port is associated;
disabling a forwarding of said network traffic to said identified egress port when it is determined that said prune action that is retrieved from said network prune control table indicates that network traffic from said source network domain should not be forwarded to said destination network domain; and
forwarding of said network traffic to said identified egress port when it is determined that said prune action that is retrieved from said network prune control table indicates that network traffic from said source network domain should be forwarded to said destination network domain.

2. The method of claim 1, wherein said ingress port is a physical port.

3. The method of claim 1, wherein said ingress port is a virtual port that is identified based on one of packet attributes and an overlay tunnel interface.

4. The method of claim 1, wherein said egress port is a physical port.

5. The method of claim 1, wherein said egress port is a virtual port that is identified based on one of packet attributes and an overlay tunnel interface.

6. The method of claim 1, wherein said retrieving is performed in an ingress pipeline of a switch.

7. The method of claim 1, wherein said retrieving is performed in an egress pipeline of a switch.

8. The method of claim 1, wherein a combination of said source domain identifier and said destination domain identifier is a key into said network prune control table.

9. The method of claim 1, wherein traffic sourced by any of a first plurality of network devices in said source network domain share said source domain identifier and traffic destined to any of a second plurality of network devices in said destination network domain share said destination domain identifier.

10. A switch, comprising:
a processor that associates a source network domain identifier and a destination domain identifier with network traffic that is received at an ingress port of the switch, wherein said source domain identifier is shared by network traffic that originates at any of a first plurality of network devices in a source network domain and said destination domain identifier is shared by network traffic destined to any of a second plurality of network devices in a destination network domain; and
a network prune control table that stores a plurality of prune actions, each of said plurality of prune actions being associated with a unique combination of a source domain identifier and a destination domain identifier, wherein an enable prune action that is retrieved from said network prune control table using a first source domain identifier and a first destination domain identifier indicates that network traffic from said first source network domain should be forwarded to said first destination network domain, and wherein a disable prune action that is retrieved from said network prune control table using a second source domain identifier and a second destination domain identifier indicates that network traffic from said second source network domain should not be forwarded to said second destination network domain.

11. The switch of claim 10, wherein said ingress port is a physical port.

12. The switch of claim 10, wherein said ingress port is a virtual port.

13. The switch of claim 10, wherein said process is associated with an ingress pipeline of the switch.

14. The switch of claim 10, wherein said process is associated with an egress pipeline of the switch.

15. The switch of claim 10, wherein a combination of said source domain identifier and said destination domain identifier is a key into said network prune control table.

16. A method, comprising:
retrieving, for network traffic received in a switch, a prune action from a network prune control table using a source domain identifier associated with a source network domain that is the source said network traffic and a destination domain identifier associated with a destination network domain that is the destination of said network traffic;
disabling, by said switch, a forwarding of said network traffic when it is determined that said prune action that is retrieved from said network prune control table indicates that network traffic from said source network domain should not be forwarded to said destination network domain; and
forwarding, by said switch, of said network traffic when it is determined that said prune action that is retrieved from said network prune control table indicates that network traffic from said source network domain should be forwarded to said destination network domain.

17. The method of claim 16, wherein said retrieving is performed in an ingress pipeline of said switch.

18. The method of claim 16, wherein said retrieving is performed in an egress pipeline of said switch.

19. The method of claim 16, wherein a combination of said source domain identifier and said destination domain identifier is a key into said network prune control table.

20. The method of claim 16, wherein traffic sourced by any of a first plurality of network devices in said source network domain share said source domain identifier and traffic destined to any of a second plurality of network devices in said destination network domain share said destination domain identifier.
